(19) United States
(12) Patent Application Publication
(10) Pub. No.: US 2012/0058452 A1
(43) Pub. Date: Mar. 8, 2012

(54) COMFORT HEAD MINI DENTAL IMPLANT

(76) Inventor: Moe Keng Ang, Kuala Lumpur (MY)

(21) Appl. No.: 13/320,082

(22) PCT Filed: Aug. 2, 2010
(86) PCT No.: PCT/MY2010/000134

§ 371 Date: Nov. 11, 2011

(30) Foreign Application Priority Data
Aug. 3, 2009 (MY) PI20093208

(51) Int. Cl. A61C 8/00

(52) U.S. Cl. 433/174

(57) ABSTRACT

A one piece screw type mini dental implant (20) with a supragingival comfort head (10) that is generally frustoconical in shape and smooth in contour and outline, with rounded edges (11). The diameter of the base (12) is bigger than the diameter of the screw portion (1) by a factor of 1.5 to 1.6. Flats (4, 6), facets (5, 9), through holes (8, 8′), slots (7, 7′), and/or grooves (13, 13′) may be provided on the supragingival head (10). These features provide a mini dental implant that feels comfortable in a patient's mouth, is easy to place, amenable to direct impression taking and applicable in prosthodontic and orthodontic use.

### BACKGROUND OF THE INVENTION

1. Technical Field of the Invention

This invention relates to one piece screw type mini dental implants in general and in particular to a mini implant with a head designed for patient comfort which also has features which enhance ease and versatility of use by dentist.

2. Description of the Prior Art

Mini dental implants have application in dental treatment in the replacement of lost teeth both for supporting fixed or removable prostheses and for orthodontic anchorage. The o-ball head mini implant as taught in U.S. Pat. No. 6,716,030 is a versatile dental implant that is easy to place and has many applications. The small size and one piece construction enables minimally invasive implant dentistry.

The o-ball head end those projects beyond the gumline after insertion into the jawbone is small and irregular. Without further modification, it is very uncomfortable for the patient. It is sharp and irregular and food gets implaled too. Further, the slim size and irregular profile with undercuts preclude a direct impression technique, which is more convenient and economical. The o-ball head design is best suited for use with a removable denture. But the suitability for use in fixed restorations and orthodontic application is limited.

There exists in the field need for a mini implant (a one piece dental implant made of Titanium alloy or other strong biocornpatible material of diameter less than 3 mm and greater than 1.2 mm)

that has a head sized and shaped such that the above mentioned drawbacks are overcome. Just as ‘comfort caps’ are well known in the field of conventional implant dentistry, the field of mini implant dentistry calls for a one piece mini implant with a ‘comfort head’.

The following description will explain further a one piece mini implant with a small diameter intrabony screw portion that enables minimally invasive implant dentistry whilst overcoming the prosthodontic/patient comfort/versatility drawbacks of the o-ball head of prior art.

### SUMMARY OF THE INVENTION

The present invention discloses a comfort head mini dental implant. It is an object of this invention to provide a mini implant of one piece construction which enables minimally invasive surgery. It is another object of this invention that this mini implant shall have a supragingival head that is amenable to easy insertion into the jawbone, and also direct impression taking after insertion into the jawbone. It is yet another object of this invention to provide this mini implant with a supragingival head that is sized and shaped to provide maximum comfort to the patient. Various features on the head can enable use in orthodontics, and provides for insertion into bone.

### BRIEF DESCRIPTION OF THE DRAWINGS

FIG. 1 is a lengthwise view of an o-ball head mini implant as per prior art

FIG. 2 is a lengthwise view of an embodiment of the present invention

FIG. 3 is a top end view of the present invention showing 2 flats cut into the supragingival head, placed opposite each other and stopping short of the base

FIG. 4 is a top end view of the present invention showing 2 flats cut into the supragingival head, placed opposite each other and extending to the base

FIG. 5 is a top end view of the present invention showing a square cut out into the supragingival head portion

FIG. 6 is a top end view of the present invention showing a hexagon cut out into the supragingival head portion

FIG. 7 is a lengthwise view of the supragingival head of this invention showing slots and through holes

FIG. 8 is a side view of the supragingival head portion showing grooves

### DETAILED DESCRIPTION OF THE DRAWINGS

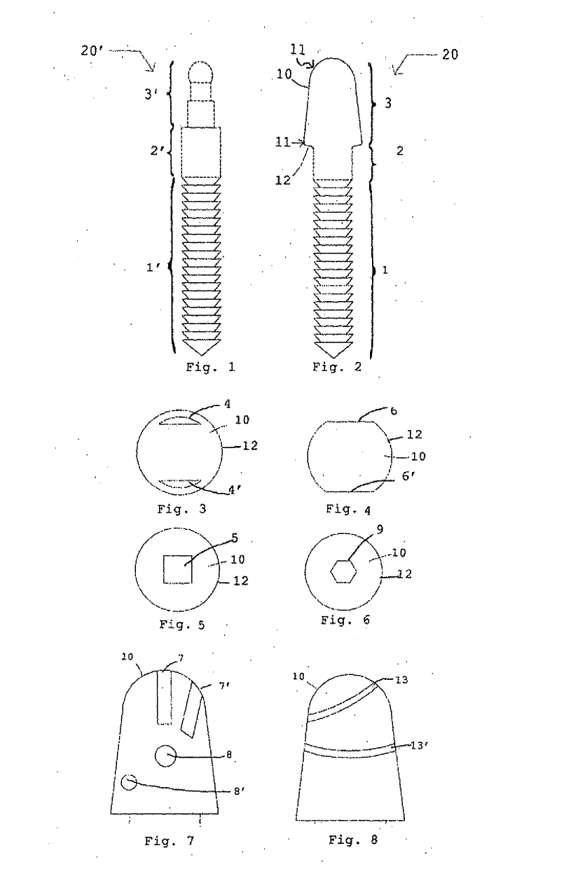

FIG. 1 is a lengthwise view of a prior art o-ball head mini implant, showing a intrabony screw portion (1′), a intragingival smooth collar (2′), and a supragingival o-ball head portion (3′). The supragingival portion (3′) is small and irregular. This makes for much discomfort to the patient as the sharp edges irritate the tongue and food gets impaled. This small size and irregular shape also precludes direct impression taking by the dentist who has to use a tedious indirect technique, which increases treatment time and cost.

FIG. 2 is a lengthwise view of an embodiment of the present invention showing an intrabony screw portion (1), an intragingival smooth collar portion (2) and a supra gingival comfort head portion (3). This is a generally frustoconical shaped head (10) that is smooth in outline and contour with rounded edges (11). This will minimize discomfort to the patient. The size of this comfort head (10) is bigger than the o-ball head portion (3′) of prior art in relation to the diameter of the screw portion. The comfort head (10) has a base (12) that extends beyond the smaller diameter of the intrabony screw portion (1). This screw portion may range in diameter from 1.2 mm to 2.9 mm and the diameter of the comfort head base (12) may range from 2.0 to 5.0 mm. The diameter of the base (12) of the comfort head (10) is bigger than the diameter of the screw portion (1) by a factor of 1.5 to 1.6. This generally bigger frustoconical shaped comfort head (10) has no undercuts and lends itself readily to direct impression taking. The height (H) could range from 3 mm to 8 mm.

In a preferred embodiment, the supragingival comfort head (10) has diameter 3.85 mm at the base (12) i.e. bigger than the 2.5 mm diameter of the screw portion (1) by a factor of 1.54 and height 5 mm. The intrabony screw portion (1) may range from 5 mm to 20mm. The smooth collar (2) continues from the screw portion (1) and has similar diameter, preferably 2.5 mm. The smooth collar (2) may be flared or cylindrical. The joint between the base (12) and the cylindrical collar (2) is preferably concave outwards.

FIGS. 3 to 8 show various means for engagement of insertion tools, wires and elastomeric rings. FIG. 3 and FIG. 4 are top end views. FIG. 3 shows 2 flats (4, 4′) diametrically placed, cut into the surface of the comfort head (10), not extending to the base (12) and FIG. 4 shows 2 flats (6, 6′) diametrically placed, cut into the surface of the comfort head (10) extending to the base (12). FIGS. 5 and 6 are top end views. FIG. 5 and FIG. 6 show multifaceted depressions cut into the top of the comfort head (10). FIG. 5 shows a square cut out (5) and FIG. 6 shows a hexagonal cut out (9). The flats (4, 4′, 6, 6′) and multifacets (5, 9) will enable engagement with insertion tools.

FIG. 7 and FIG. 8 are side views of the comfort head (10). FIG. 7 shows slots (7, 7′) may be positioned anywhere on the comfort head (10). Through holes or partial holes (8, 8′) may be positioned anywhere on the comfort head (10). FIG. 8 shows grooves (13, 13′) cut into the surface of the comfort head (10). These grooves (13, 13′) may be partial or circumferential, placed horizontally or at incline. These features enable engagement with wires and elastomeric rings and various insertion means.

The foregoing description has disclosed a mini implant with a supragingival comfort head (10) bigger in size than the slim screw portion (1). The size and shape of this comfort head (10) enhance comfort to the patient and enables a direct impression technique whilst acting as a better foundation for fixed prosthodontic restorations. The various features on the comfort head like facets (4, 6, 5, 9), slots (7), holes (8) and grooves (13) enhance the versatility of this mini implant. It is to be noted that the teaching of this invention is not limited to the disclosed features only, as many other adaptations according to the principles set out are possible.

1. A one piece mini dental implant (20) made of biocompatible material having an intrabony screw portion (1) with diameter ranging from 1.2 mm to 2.9 mm, an intragingival smooth collar (2), and a supragingival head (3) wherein the supragingival head (3) is generally frustoconical in shape (10), and the diameter of the base (12) is bigger than the diameter of the intrabony screw portion (1) by a ratio of 1.5 to 1.6 and the height (H) ranges from 3 mm to 8 mm.

2. A one piece mini dental implant (20) as in claim 1 made of titanium alloy.

3. A one piece mini dental implant (20) made of stainless steel.

4. A one piece mini dental implant (20) as in claim 1 wherein the diameter of the intrabony screw portion (1) is 2.5 mm.

5. A one piece mini dental implant (20) as in claim 1 wherein the diameter of the base (12) is bigger than the diameter of the intrabony screw portion (1) by a ratio of 1.54.

6. A one piece mini dental implant (20) as in claim 1 wherein the height (H) of the supragingival head (10) is 5 mm.

7. A one piece mini dental implant (20) as in claim 1 wherein the intragingival smooth collar (20) is cylindrical.

8. A one piece mini dental implant (20) as in claim 1 wherein the intragingival smooth collar (2) tapers outwardly.

9. A one piece mini dental implant (20) as in claim 1 wherein the contour and edges (11) of the supragingival head (3) are smooth and rounded.

10. A one piece mini dental implant (20) as in claim 1 wherein the supragingival head (3) is provided with diametrically placed flats (4, 4′ or 6, 6′).

11. A one piece mini dental implant (20) as in claim 1 wherein the supragingival head (3) is provided with multifacets (5, 9).

12. A one piece mini dental implant (20) as in claim 1 wherein the supragingival head (3) is provided with one or more slots (7, 7′).

13. A one piece mini dental implant (20) as in claim 1 wherein the supragingival head (3) is provided with one or more through holes (8, 8′).

14. A one piece mini dental implant (20) as in claim 1 wherein the supragingival head (3) is provided with one or more grooves (13, 13′).
